(19) United States
(12) Patent Application Publication
(10) Pub. No.: US 2025/0169595 A1
(43) Pub. Date: May 29, 2025

(54) TEXTILE PRESSURE SENSING SYSTEM AND METHOD

(71) Applicant: MYANT INC., Toronto (CA)

(72) Inventors: Amirali TOOSSI, Toronto (CA); Milad ALIZADEH-MEGHRAZI, Toronto (CA); Ladan ESKANDARIAN, Toronto (CA); Amin MAHNAM, Toronto (CA); Sahar GOLMOHAMMADI ROSTAMI, Toronto (CA)

(21) Appl. No.: 18/840,343

(22) PCT Filed: Nov. 30, 2022
(86) PCT No.: PCT/CA2022/051749

§ 371 Date: Aug. 21, 2024

Related U.S. Application Data
(60) Provisional application No. 63/312,433, filed on Feb. 22, 2022.

(51) Int. Cl. A45F 3/04; G01L 1/14

(52) U.S. Cl. CPC A45F 3/04; G01L 1/142

(57) ABSTRACT

There is provided a system and method for pressure sensors using single or multilayer configurations. Pressure sensors may be created by separating conductors with an insulating layer and determining a change in capacitance when a force or pressure is applied. The change in capacitance may be mapped to a corresponding force or pressure.

### CROSS-REFERENCE TO RELATED APPLICATIONS

This claims the benefit of U.S. Provisional Patent No. 63/312,433, filed on Feb. 22, 2022, the entire contents of which are incorporated by reference herein.

### FIELD

This relates generally to systems for sensing pressure, and particular to pressure sensing systems incorporated into textiles.

### BACKGROUND

With growing advances in Internet of Things (IoT) technologies, smart spaces, Augmented Reality/Virtual Reality (AR/VR), and wearables, there is a greater opportunity than ever to collect information from both living beings as well as their surroundings. To this end, novel unobtrusive sensing technologies are essential for expanding and complementing the richness of data gathered. Such data includes the measurement of pressure and/or forces at various interfaces and locations in an environment during tactile interactions. The accuracy and granularity of such data is critical in achieving a proper understanding of events being observed and interactions with the world (such as, for example, the controlled manipulation of objects).

However, pressure and force are parameters which are mechanically dynamic in nature, and moving parts present unique challenges. For example, conventional flexible sensors and electronics lack longevity and suffer performance degradation and may break entirely when undergoing repeated mechanical deformations, which results in limited life cycle usage for products and a steady reduction of accuracy through the life cycle usage.

Accordingly, there is a need for force/pressure sensing electronics with greater longevity and durability under repeated mechanical deformation.

### SUMMARY

According to an aspect, there is provided a system for sensing pressure, the system comprising: a pressure sensor comprising: an inner conductive core; a conductive layer coaxial with said conductive core; an insulating layer disposed between said conductive core and said conductive layer; and an outer insulating layer coaxial with and disposed on said conductive layer; and a computing device configured to detect a capacitance of said pressure sensor and determine a pressure applied to said pressure sensor based on a change in said capacitance.

According to another aspect, there is provided a system for sensing pressure, the system comprising: a first layer comprising a first plurality of conductive elements in a first configuration; a second layer comprising a second plurality of conductive elements in a second configuration, wherein said first layer and said second layer are combined to form a plurality of pressure sensors at points of intersection between said first plurality of conductive elements and said second plurality of conductive elements; and a computing device configured to detect a capacitance of one or more of said plurality of pressures sensors and determine a pressure applied to said one or more of said pressure sensors based on a change in said capacitance.

According to another aspect, there is provided a method of assembling a pressure sensing device, the method comprising: providing a first layer having a first plurality of conductive elements disposed thereon in a first configuration; providing a second layer having a second plurality of conductive elements disposed thereon in a second configuration; combining said first and second layers to create a plurality of pressure sensors at points of intersection between said first and second pluralities of conductive elements; measuring changes in capacitance at one or more of said pressure sensors; determining a pressure applied to said one or more pressure sensors based on said changes in capacitance.

Other features will become apparent from the drawings in conjunction with the following description.

### BRIEF DESCRIPTION OF DRAWINGS

In the figures which illustrate example embodiments,

FIG. 1 is a perspective view of an example embodiment of a single layer fabric textile pressure sensor;

FIG. 2 is an example embodiment of a pressure sensor implemented as a multilayer fabric;

FIG. 3 is an exploded perspective view of the multilayer fabric shown in FIG. 2;

FIG. 4 depicts the observed output capacitance at various stages of a cyclic loading test of a pressure sensor as described herein, demonstrating robustness and stability of responses;

FIG. 5A is a perspective view of a footwear article;

FIG. 5B is an exploded view of the computing device housing shown in FIG. 5A;

FIG. 6 is a block diagram depicting components of an example computing device;

FIG. 7 is a schematic diagram of an example embodiment of an insole comprising a plurality of pressure sensors as described herein;

FIG. 8 is an illustration of a user wearing shoes containing a pressure sensing insole, together with a heat map of the corresponding resulting pressures measured at various locations of insole;

FIGS. 9A is a schematic diagram of an array of pressure sensors as described herein located on the back panel of a backpack;

FIG. 9B is a schematic diagram of an array of pressure sensors as described herein located on the straps of a backpack;

FIG. 10 is an illustration of a software platform configured to present a visualization of the pressure data received from the pressure sensors in the back and strap portions of the backpack;

FIG. 11 is an illustration of a software platform configured to present a visualization of pressure data received from pressure sensors in a pressure-sensing mat; and

FIG. 12 is a schematic diagram for a pressure sensing mat.

### DETAILED DESCRIPTION

Various aspects of preferred embodiments of systems for sensing pressure and/or force according to the disclosure are described herein with reference to the drawings.

As used hereinafter, references to pressure (i.e. a force distributed over an area) and force may be used interchangeably, as will be understood by a person skilled in the art. Flexible sensors and electronics may offer advantages including being light-weight, flexible, and low-cost. Disclosed herein is a novel textile sensing technology which may be incorporated into devices ranging from wearables, to smart surfaces, smart homes, and various other applications.

As noted above, one of the challenges associated with existing flexible-electronics based pressure sensors is poor longevity when undergoing repeated mechanical deformation. This results in a limited life cycle usage of the sensor and gradual reduction in accuracy throughout the sensor's life cycle. Such degradation may be caused by, for example, breakdown of capacitors due to peeling or cracking, and/or creasing caused by the natural curvature of the object applying the pressure (e.g. a user's foot or heel), as well as the non-formable nature of the flexible materials used in the sensor.

Some embodiments of the present invention may address the above-noted challenges and may be highly flexible, conforming effectively to applied surfaces and/or body parts, and substantially more resilient to repeated mechanical compression and/or deformation relative to existing flexible-electronics based pressure sensors. For example, some embodiments may show negligible or no degradation in performance even after 1 million cycles of repeated 100 kg loading. Contrastingly, printed or flexible electronics experience creasing and functional degradation and loss over time across sensing areas which include non-flat interfaces.

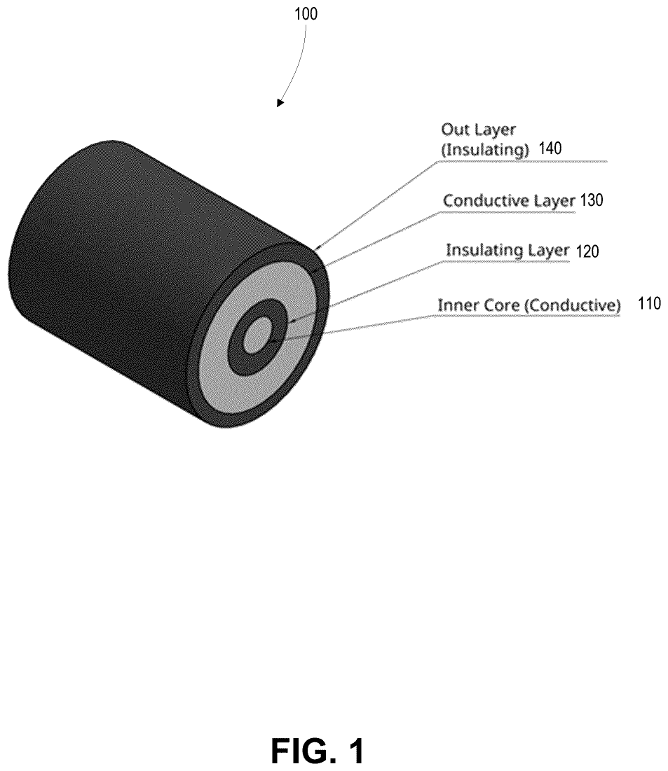

In some embodiments, textile pressure sensors may be implemented in a single layer fabric form. FIG. 1 is a perspective view of an example embodiment of a single layer fabric textile pressure sensor 100. As depicted, pressure sensor 100 includes inner conductive core 110, insulating layer 120, conductive layer 130, and outer layer 140.

In some embodiments, pressure sensor 100 senses pressure by measuring electrical capacitance. For example, in a single layer fabric pressure sensor, insulated conductive yarns may be any of knitted, weaved and/or interleaved with non-insulated conductive yarns, thereby forming a capacitor at their interface across the insulating dielectric layer. In some embodiments, as depicted in FIG. 1, a textile sensor 100 may include conductive yarns and/or fibres with a dieletric layer 120 in between, thus creating an element with an electrical capacitance.

Such conductive yarns may range in gauge and material type. For example, gauge may range from gauge 4 to 30, or 10 Denier to 250 Denier. For example, in some embodiments, conductive yarns may include poly(3,4-ethylenedioxythiphene) polystyrene sulfonate (PEDOT:PSS), silver, gold, platinum, stainless steel, copper, brass, aluminum, and/or any alloys of the foregoing.

In some embodiments, dieletric layers 120 may include a range of textile, polymer, and/or plastic materials. In some embodiments, materials for a dielectric layer may include, for example, wool, cotton, tencil, TPU, TPE, PU, polyeyester, parylene, and the like. In some embodiments, dieletric layers may be in the form of knitted and/or weaved fabrics, and may also be in the form of insulated coatings 140 over the conductive yarns and/or fibers.

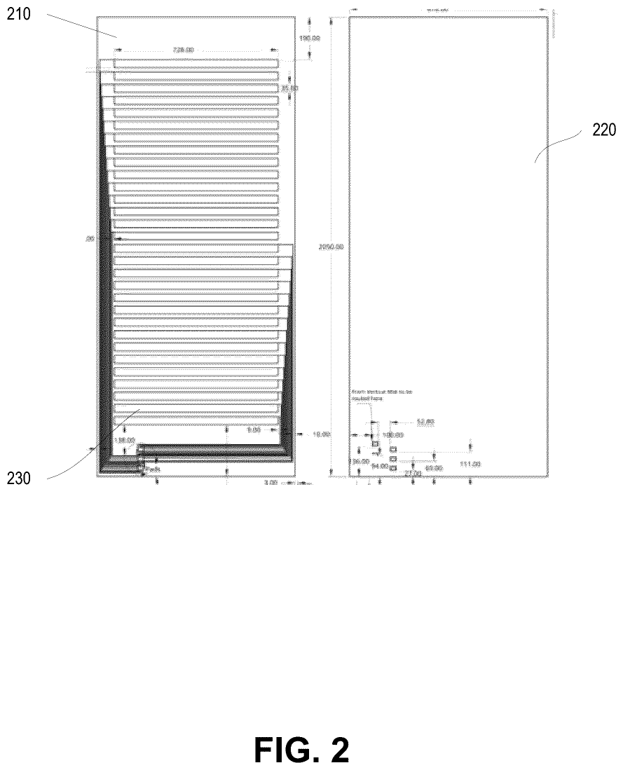

In some embodiments, textile capacitive pressure sensors 200 may be formed as a multilayer fabric with conductive layer planes sandwiching the dielectric layer. FIG. 2 is an example embodiment of a pressure sensor 200 implemented as a multilayer fabric. As depicted, pressure sensor 200 comprises a first layer 210 and a second layer 220. In some embodiments, first layer 210 and second layer 220 may be brought together (or “sandwiched”) to form a multilayer fabric pressure sensor 200. In some embodiments, first layer 210 and second layer 220 are sandwiched with a dielectric layer therebetween.

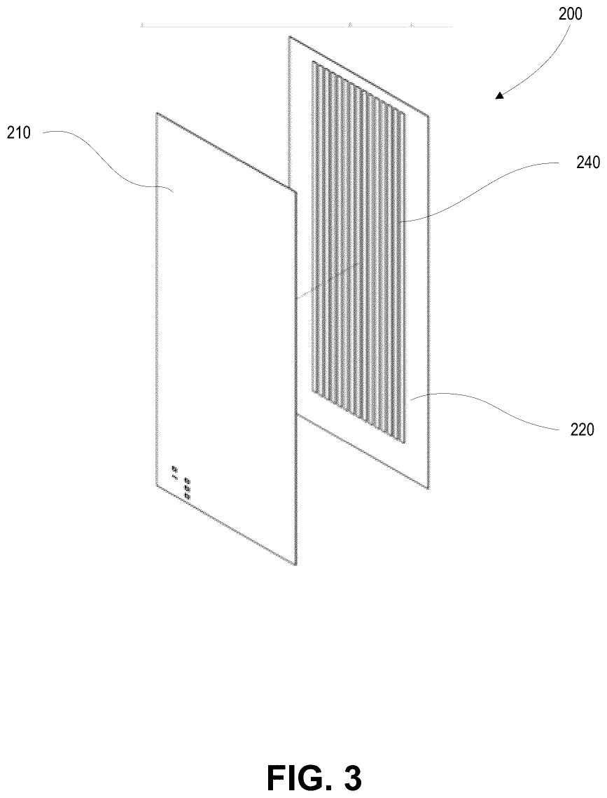

In some embodiments, first layer 210 may include conductive regions of various shapes including but not limited to lines 230. In some embodiments, second layer 220 may include conductive regions of various shapes including but not limited to lines 240. In some embodiments, first layer 210 and/or second layer 220 may be printed circuit boards (PCBs) with conductive line patterns disposed therein. In some embodiments, conductive lines 230, 240 may be conductive yarns. In some embodiments, conductive lines 230, 240 may be covered by an insulative layer. As depicted, conductive yarns 230 may be arranged in a horizontal line pattern. In some embodiments, conductive yarns 240 may be arranged in a vertical line pattern. Thus, when first layer 210 and second layer 220 are brought together, the intersections of yarns 230 and 240 will form a grid of squares or rectangles. In some embodiments, when a dielectric layer is present between first layer 210 and second layer 220, each of said intersections may operate as a pressure sensor. Thus, pressure sensor 200 depicted in FIGS. 2 and 3 includes a grid of pressure sensors.

In some embodiments, when a load (e.g. a force or pressure) is applied to pressure sensor 100, 200, the spacing between conductive layers will reduce, thereby causing a change in the measured capacitance. Therefore, the force or pressure applied to the pressure sensor 100, 200 may be determined by determining a relation between the change in capacitance and applied force/pressure. In the case of pressure sensor 200, a computing device 500 may be configured to read the multisensory/multicapacitive matrix, which may provide a more efficient implementation for a large number or high density sensor array of pressure sensors.

It will be appreciated that although FIGS. 2 and 3 depict horizontal and vertical lines, any configuration for lines may be chosen, and the resulting intersection pattern between yarns 230, 240 may be shapes other than square or rectangles for pressure sensor 200.

In some embodiments, changes in any of pressure, force, or stretch over pressure sensor 200 will cause a change in conductor spacing and/or area, which in turn results in a change in capacitance in a particular area. Advantageously, pressure sensors such as pressure sensor 200 and pressure sensor 100 may represent substantial improvements in durability and longevity relative to existing pressure sensor designs.

For example, when exposed to repeated loading, the performance of some embodiments of pressure sensors 100, 200 has been found to be substantially similar even after subjecting sensors 100, 200 to as many as 1,000,000 loading cycles of 100 kg of weight (which corresponds to roughly 1.089 MPa given an approximate area of 9 cm² to which the load was applied). That is, pressure sensors 100, 200 are resistant to degradations in performance after 1,000,000 cycles of being loaded with 100 kg of weight (1.089 MPa).

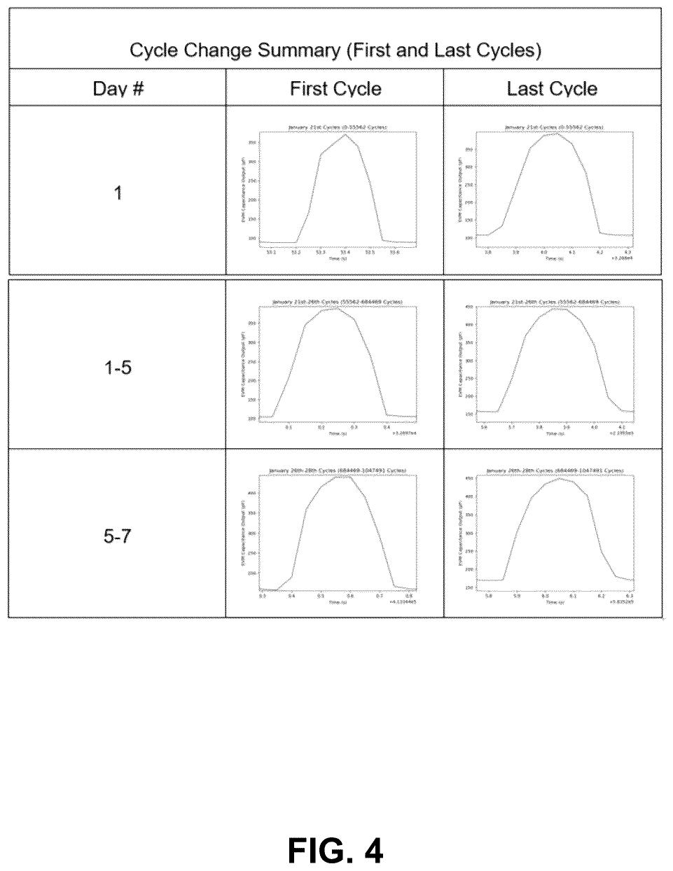

FIG. 4 depicts the observed output capacitance at various stages of a loading test of a pressure sensor as described herein. For example, the first cycle of day 1 represents the waveform of the capacitance during loading during the first cycle of the test, and the last cycle of day 1 is the 55,562^{nd} cycle. The first cycle of the second row in FIG. 4 represents the 55,563^{rd} cycle, and the last cycle in the second row of FIG. 4 represents the 684,469^{th} cycle. Finally, the first cycle in the third row of FIG. 4 represents the 684,470^{th} cycle, and the last cycle represents the 1,047,491^{st} cycle. As will be appreciated, during testing the observed capacitance of an example embodiment (an insole form factor for a shoe) during loading did not change appreciably over the course of 1,000,000 cycles of loading a pressure sensor as described herein with 100 kg of mass. In some embodiments, pressure sensors as described herein connect to a computing device 500 which processes, interprets, and/or transmits recorded pressure data to other computing systems.

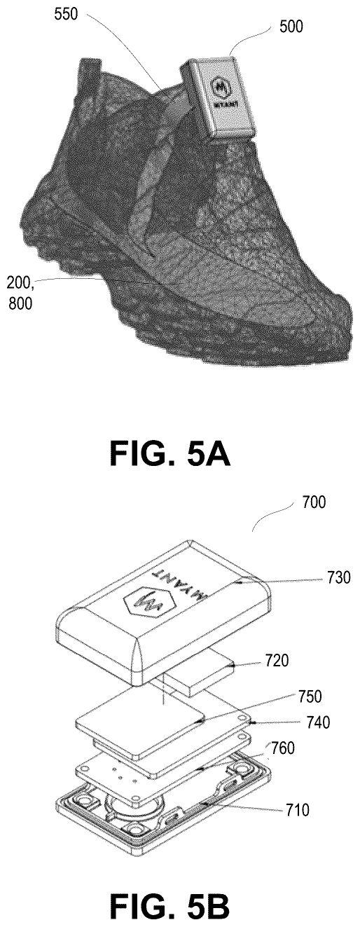

As depicted in FIG. 5A, computing device 500 may be placed within a protective housing 700 which shields the electronic components from the elements and/or impact. As depicted in FIG. 5B, housing 700 may include one or more of base 710, power source 720 (e.g. a battery), cover 730, daughter board 740, motherboard 750, and/or textile board 760.

In practice, a common failure point of systems incorporating pressure sensors 100, 200 may be the location at which wires for connection to computer device 500 are integrated with the textile. In some embodiments, such a point of failure may be avoided by removing wired connections from the area in which pressure is sensed (via, for example, silver traces and/or a flap). In some embodiments, a connection method for connecting wire to textile may include, for example, heat staking connectors 550 (as shown, for example, in FIG. 5A), crimping boards, directly embroidered boards, low melt soldering and adhesives, ultrasonic welding, z-axis, and/or embedded electronics via conformal coatings and/or injection molding. Any or all of the aforementioned connection methods may be viable options and may be selected as appropriated based on, for example, the environment and/or the application of the form factor. In some embodiments, the aforementioned connection methods may allow for a 2-60 pin connection. In some embodiments, connectors 550 may include such connection methods as disclosed in U.S. Patent Publication No. 2021/0052222 and International Patent Publication WO 2020/257933, the contents of which are incorporated by reference in their entireties.

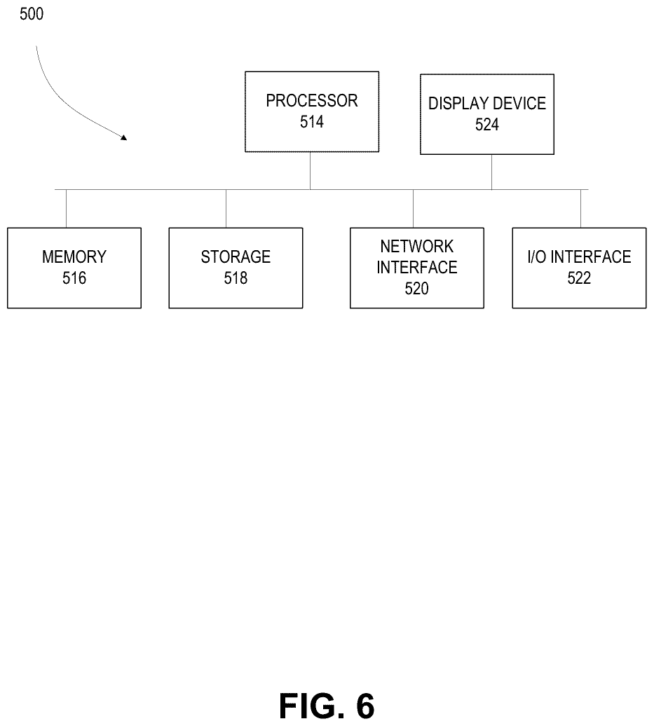

FIG. 6 is a block diagram depicting components of an example computing device 500. As depicted, computing device 500 includes a processor 514, memory 516, persistent storage 518, network interface 520, and input/output interface 522.

Processor 514 may be an Intel or AMD x86 or x64, PowerPC, ARM processor, or the like. Processor 514 may operate under the control of software loaded in memory 516. In some embodiments, storage 518 may store sensor data received from pressure sensors, and for general data logging.

Network interface 520 connects computing device 500 to one or more communication networks. Network interface 520 may support domain-specific networking protocols. I/O interface 522 connects computing device 500 to one or more storage devices, and peripherals such as keyboards, mice, pointing devices, USB devices, disc drives, display devices 524, and the like.

In some embodiments, I/O interface 522 connects various sensors and other specialized hardware and software used in pressure sensing applications to processor 514 and/or to other computing devices. In some embodiments, I/O interface 522 may be used to connect computing device 500 to other computing devices and provide access to various sensors and other specialized hardware and software.

In some embodiments, I/O interface 522 may be compatible with protocols such as WiFi, Bluetooth, and other communication protocols. Software may be loaded onto computing device 500 from peripheral devices or from a network. Such software may be executed using processor 514.

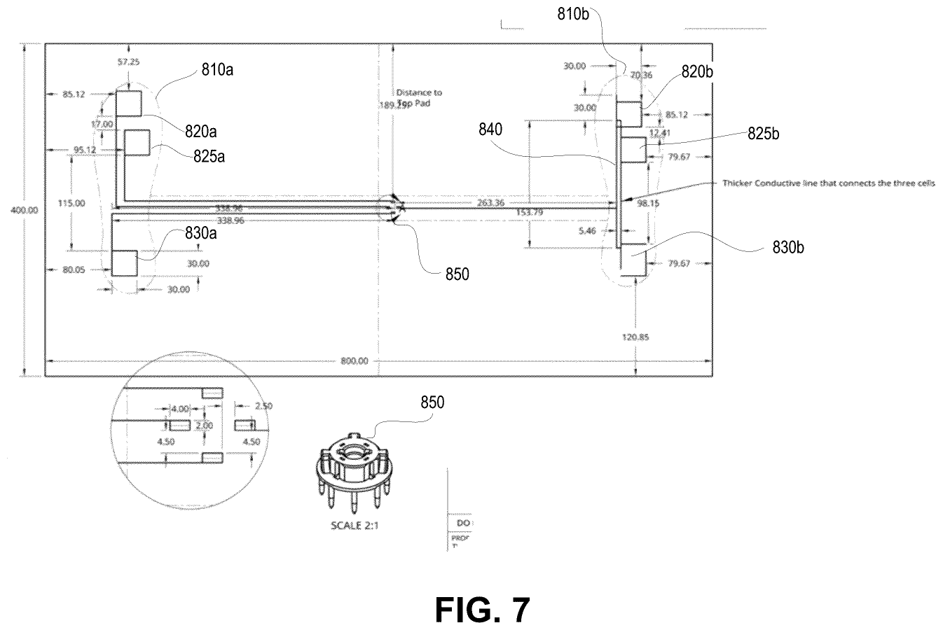

Embodiments described herein may have numerous applications across a wide variety of domains. For example, some embodiments may be used as an insole for footwear, as shown in FIG. 5A. FIG. 7 is a schematic diagram of an example embodiment of an insole comprising a plurality of pressure sensors 200. It will be appreciated that dimensions indicated in various figures throughout this disclosure are intended to be examples, and that other dimensions and proportions are contemplated in accordance with the principles described herein. It will also be appreciated that although FIG. 5A depicts connectors 550 mounted on the tongue of the footwear, it is contemplated that connectors 550 can be mounted anywhere on the footwear (for example, on the sides, the back, or any other location).

In some embodiments, insole 800 may be constructed as a multilayer fabric pressure sensor. As depicted insole 800 comprises first layer 810a and second layer 810b. First layer 810a includes three cells 820a, 825a, 830a of conductive lines. Second layer 810b includes three cells 820b, 825b, 830b of conductive lines. As depicted, a conductive line 840 may electrically connect cells 820b, 825b, 830b. In some embodiments, conductive line 840 may be thicker than conductive lines within cells 820b, 825b, 830b. In some embodiments, cells 820a, 825a, 830a in first layer 810a may be electrically connected to conductive line 840 by a connector 850.

In some embodiments, the relative orientation of conductive lines within cells 820a, 825a, 830a and cells 820b, 825b, 830b may be similar to orientations of conductive lines in the first and second layers depicted in FIGS. 2 and 3. It will be appreciated that although FIG. 7 depicts 3 cells in each layer, it is contemplated that other embodiments include more than 3 cells and/or less than 3 cells.

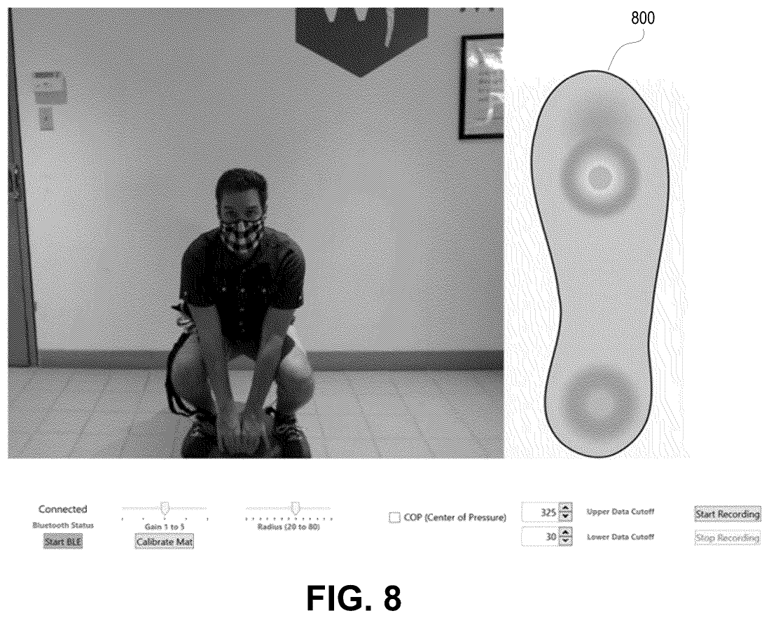

In some embodiments, first layer 810a and second layer 810b are configured to be folded or otherwise placed overtop of one another, thereby creating an array of capacitive pressure sensor elements within insole 800. As noted above, insole 800 may be electrically connected to a computing device 500 configured to perform any of receiving, processing, and/or transmitting pressure sensing data to another computing device for processing. In operation, a user may place insole 800 within a shoe and then stand in various positions, thereby applying force in various locations to insole 800. FIG. 8 is an illustration of a user wearing shoes containing a pressure sensing insole 800, together with a heat map of the corresponding resulting pressures measured at various locations of insole 800.

In some embodiments, a computing device communicatively coupled to computing device 500 may be configured to execute a software platform which can communicate with and/or control sensing parameters of pressure sensors in various form factors. In some embodiments, the software platform may provide the user with a range of capabilities, including but not limited to performing sensor calibration, adjusting sensor gains, visualizing and saving raw pressure measurements, transformations of pressure data (e.g. center pressure calculations), debugging non-functional sensors, wirelessly programming the firmware of computing device 500, checking battery status, checking connection status, receiving Global Positioning System (GPS) coordinates over time, and/or sampling frequency modifications.

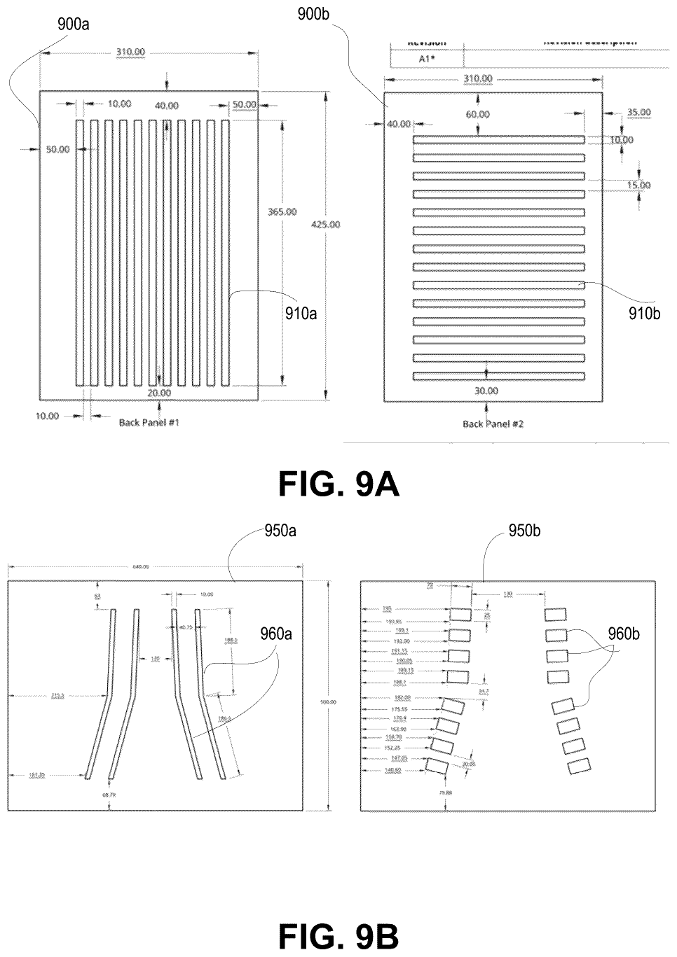

According to another embodiment, pressure sensing devices described herein may be incorporated into one or more locations on a backpack. For example, FIGS. 9A is a schematic diagram of an array of pressure sensors as described herein located on the back panel of a backpack. FIG. 9B is a schematic diagram of an array of pressure sensors as described herein located on the straps of a backpack.

As depicted in FIG. 9A, the back-touching portion of a backpack may include first layer 900a and second layer 900b. First layer 900a may include a plurality of conductive sections 910a, and second layer 900b may include a plurality of conductive sections 910b. As described above, layers 900a, 900b may be overlaid to form a plurality of pressure sensors between sections 910a, 910b.

Similarly, as depicted in FIG. 9B, the straps of a backpack may include first layer 950a and second layer 950b. First layer 950a may include a plurality of conductive sections 960a, and second layer 950b may include a plurality of conductive sections 960b. First layer 950a and second player 950b may be overlaid to form a plurality of pressure sensors between sections 960a, 960b. The resulting pressure sensors in the back and strap portions of the backpack may be connected to a computing device 500, which may receive, process, and/or transmit recorded pressure data from the sensors.

It will be appreciated that although FIGS. 9A and 9B depict a particular number of conductive sections 910a, 910b, 960a, 960b, it is contemplated that embodiments may include more conductions sections and/or less conductive sections in any or all portions of a pressure-sensing backpack, and that the configurations depicted are merely example embodiments.

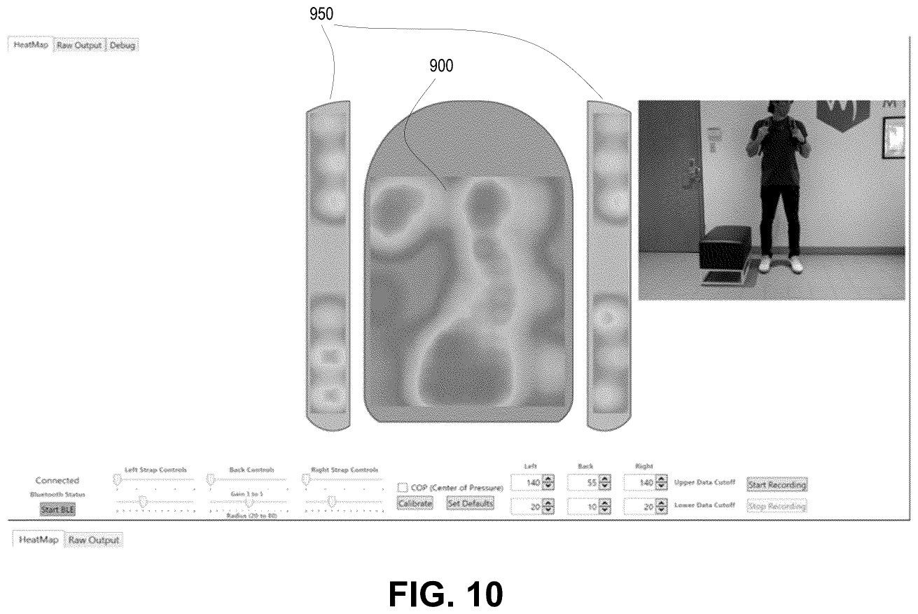

FIG. 10 is an illustration of a software platform configured to present a visualization of the pressure data received from the pressure sensors in the back 900 and strap 950 portions of the backpack. In some embodiments, different colours may be used to depict a heatmap, in which higher recorded pressures are depicted with, for example, a red colour, and lower recorded pressures are depicted using green or blue. It will be appreciated that heatmaps typically use a continuum of colours so as to convey the gradual nature of transitions from high pressure to low pressure regions.

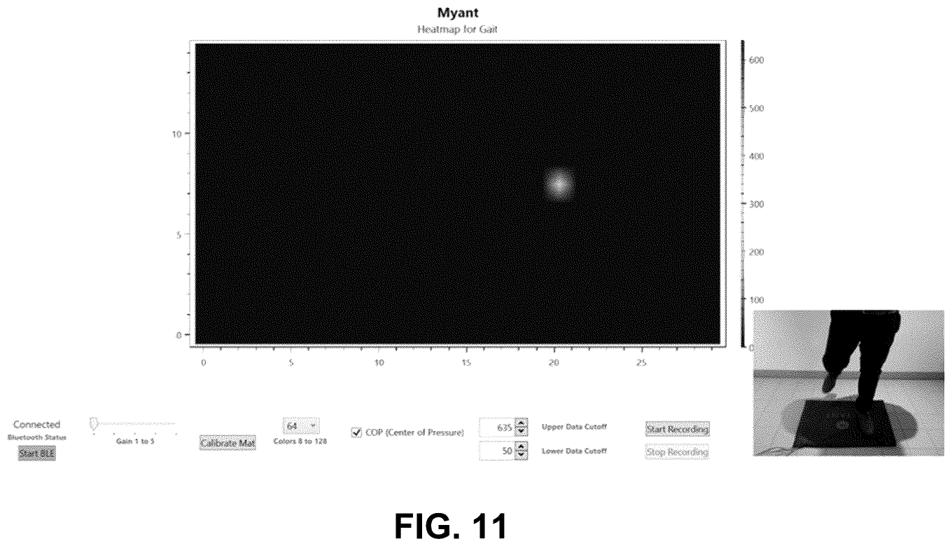

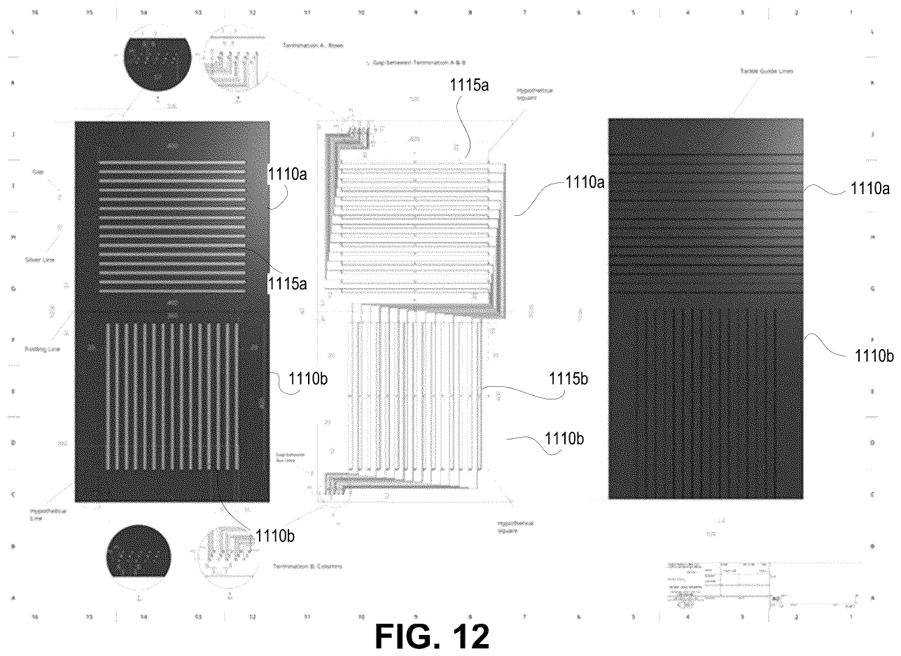

FIG. 11 is an illustration of a software platform configured to present a visualization of pressure data received from pressure sensors in a pressure-sensing mat 1100. An example configuration for a mat containing multilayer pressure sensors is shown in FIG. 12. As depicted, a user or object may stand or be placed on mat 1100, and the array of pressure sensors within mat 1100 records changes in capacitance, which are reflective of pressure and/or force being applied to the sensors. This may be useful for various tasks, including gait and posture analysis.

FIG. 12 is a schematic diagram for a pressure sensing mat 1100. In some embodiments, mat 1100 may be fabricated using flexible electronics which may be folded over in order to produce the resulting multilayer electronic pressure sensors. As depicted, first layer 1110a contains a plurality of conductive sections 1115a, and second layer 1110b contains a plurality of conductive sections 1115b. When folded over and placed in contact, conductive sections 1115a, 1115b form multilayer pressure sensors, as described herein.

It will be appreciated that pressure sensors as described herein may be incorporated into virtually any textile application and may provide useful pressure data. Such data may in turn be transmitted and shared with other computing devices 500, such as those pertaining to heathcare providers, other health applications, and as well as community/friends/family.

In some embodiments, computing device 500 may be configured to communicate wirelessly with pressure sensors. In some embodiments, computing device 500 communicates via wired connection with pressure sensors. Some embodiments of computing device 500 may be capable of communicating with and/or otherwise interacting with up to 900 pressure sensing elements. In some embodiments, a sampling frequency of up to 250 Hz may be used for collecting data from pressure sensors.

As noted above, storage 518 may be used for data logging. In some embodiments, computing device 500 may further include on-board inertial measurement units and photoplethysmogram (PPG) sensing units. Some embodiments may further include GPS capabilities. Some embodiments may further include wired and/or wireless charging capabilities for battery units.

Given the versatility of the above-described pressure sensing units and their robustness and durability under repeated loads and strain, there is a wide area of application for such technologies. Pressure sensing units in accordance with the embodiments described here may be used, for example, in mat or mattress form factors, including but not limited to: car seats, yoga mats, floor mats, beds, hospital beds, and may measure properties including but not limited to: heartbeat, gait, pressure sore prevention, sleep study, accessible keyboard or buttons, and industry 4.0.

Still further embodiments incorporating the pressure sensing devices described herein may include wearables, including but not limited to: socks, prosthetic socks/sleeves, medical compression, AR/VR garments (e.g. gloves), auto-formable seats, soft robotics, sleeves, and/or backpacks. Such wearables may be configured to measure one or more of blood pressure, pressure sore prevention, diabetics pressure applications, protective equipment and headgear, breathing, remote rehabilitation, sensory feedback, virtual fitting rooms (e.g. to measure the fit of a garment on a user), Telehealth/Telemedicine from robotic surgery or feedback, and industry 4.0.

Still further embodiments incorporating the pressure sensing devices described herein may include insoles, which may have applicants for one or more of gait, injury prevention for weight lifting, worker safety, AI-based personal sports coaches, AR/VR injury prevention, and employee health and workplace injury prevention.

Still further embodiments of the pressure sensors/sensing device described herein may include breathing sensors, which measure changes in strain caused by a subject's inhaling and exhaling.

Still further embodiments of the pressure sensors/sensing devices described herein may be implemented in wearable garments which measure changes in muscle activity-induced deformation and force myography (FMG).

Still further embodiments may incorporate the use of pressure sensors described herein as an additional tool for applications which require multiple sensory modalities. For example, contact pressure feedback data may be used to ensure appropriate conformal contact between electrophysiological sensors and dry skin (e.g. ECG, EEG, EMG measurements using dry electrodes). Further applications may include sleep staging and sleep studies, in which pressure sensors may be used as a standalone tool, or to support traditional polysomnography datasets. This may be particularly useful in replacing currently utilized videography methods (which are rife with privacy and user adoption issues) for sleep monitoring. Further applications may include adding kinetics measurements by combining pressure sensors in the form of a mat with EMG and/or motion capture systems, to provide more comprehensive gait studies.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A system for sensing pressure, the system comprising:
a pressure sensor comprising:
an inner conductive core;
a conductive layer coaxial with said conductive core;
an insulating layer disposed between said conductive core and said conductive layer; and
an outer insulating layer coaxial with and disposed on said conductive layer; and
a computing device configured to detect a capacitance of said pressure sensor and determine a pressure applied to said pressure sensor based on a change in said capacitance.

2. The system of claim 1, wherein said conductive layer is a conductive yarn.

3. The system of claim 1, wherein said conductive layer comprises one of poly(3,4-ethylenedioxythiphene) polystyrene sulfonate (PEDOT:PSS), silver, gold, platinum, stainless steel, copper, brass, aluminum, or an alloy thereof.

4. The system of claim 1, wherein the insulating layer comprises one or more of wool, cotton, tencil, TPU, TPE, PU, polyester, and parylene.

5. The system of claim 4, wherein the insulating layer is formed as a knitted/weaved fabric or an insulating coating.

6. A system for sensing pressure, the system comprising:
a first layer comprising a first plurality of conductive elements in a first configuration;
a second layer comprising a second plurality of conductive elements in a second configuration, wherein said first layer and said second layer are combined to form a plurality of pressure sensors at points of intersection between said first plurality of conductive elements and said second plurality of conductive elements; and
a computing device configured to detect a capacitance of one or more of said plurality of pressures sensors and determine a pressure applied to said one or more of said pressure sensors based on a change in said capacitance.

7. The system of claim 6, wherein at least one of said first plurality of conductive elements and said second plurality of conductive elements is insulated by an insulating layer.

8. The system of claim 6, wherein said computing device is connected to said plurality of pressure sensors via one or more of heat taking connectors, crimping boards, embroidered boards, low melt soldering, ultrasonic welding, z-axis, and embedded electronics.

9. The system of claim 6, wherein said plurality of pressure sensors is incorporated into one of an insole, a shoe, a mat, a blanket, a bed sheet, a mattress, and/or a garment.

10. The system of claim 6, wherein said plurality of pressure sensors is incorporated into one or more straps of a backpack and/or a back portion of a backpack.

11. The system of claim 6, wherein said computing system is configured to display a heat map depicting a distribution of determined pressures or pressure measurement values across said plurality of pressure sensors.

12. The system of claim 6, wherein a dielectric layer is positioned between said first layer and said second layer.

13. A method of assembling a pressure sensing device, the method comprising:
providing a first layer having a first plurality of conductive elements disposed thereon in a first configuration;
providing a second layer having a second plurality of conductive elements disposed thereon in a second configuration;
combining said first and second layers to create a plurality of pressure sensors at points of intersection between said first and second pluralities of conductive elements;
measuring changes in capacitance at one or more of said pressure sensors;
determining a pressure applied to said one or more pressure sensors based on said changes in capacitance.

14. The method of claim 14, further comprising positioning a dielectric layer between said first layer and said second layer.

15. The method of claim 14, wherein at least one of the first plurality of conductive elements and the second plurality of conductive elements is insulated by an insulating layer.
